(19) United States
(12) Patent Application Publication
(10) Pub. No.: US 2010/0177120 A1
(43) Pub. Date: Jul. 15, 2010

(54) SYSTEM AND METHOD FOR STRETCHING 3D/4D SPATIAL HIERARCHY MODELS FOR IMPROVED VIEWING

(75) Inventor: Robert E. Balfour, Bethpage, NY (US)

Correspondence Address: OSTROLENK FABER GERB & SOFFEN, 1180 AVENUE OF THE AMERICAS, NEW YORK, NY, 100368403, US

(73) Assignee: BALFOUR TECHNOLOGIES LLC, Hicksville, NY (US)

(21) Appl. No.: 12/352,920

(22) Filed: Jan. 13, 2009

(51) Int. Cl. G09G 5/00; G06T 11/20; H04N 7/18; G08B 21/00; G06F 3/048

(52) U.S. Cl. 345/647; 345/440; 348/143; 340/540; 715/848

(57) ABSTRACT

A system and method for spatially stretching visual interactive computer-based renderings of hierarchical 3D/4D object models is disclosed. Hierarchical 3D/4D object models are transformed into a stretchable structure. Utilizing user interface controls, a user manipulates and visually stretches the 3D/4D object model hierarchy to expose 3D/4D object model components for an unobstructed view. Real-time geo-referenced data feeds are processed to interactively update specific sensor objects contained as components of the hierarchical 3D/4D object models. Real-time geo-referenced tracking data feeds are also processed to dynamically include new visual components of the 3D/4D object model hierarchy at the proper location, representative of the locations of mobile tracking devices within the 3D/4D object model hierarchy.

### BACKGROUND

1. Field of the Disclosure

The present disclosure relates, generally, to computer graphics and, more particularly, to adjusting the spatial hierarchy of a set of 3D/4D object models in a 3D visual scene.

2. Description of the Related Art

In the field of computer graphics, computer-based 3D/4D visualization systems and methods are known. An example of one such system and method for visualizing 4D objects in a 3D computer-generated visual scene is disclosed in U.S. Pat. No. 7,057,612, which is hereby incorporated herein by reference in its entirety.

Referring now to the drawings, wherein like reference numerals refer to like elements, there is shown in FIG. 1 a prior art block diagram of the system components. Using the prior art method described in FIG. 2 below, 4D portal databases 1 are derived from information databases 16. The 4D server 25, described in FIG. 3 below, accesses one or more 4D portal databases 1 and transmits 4D portal information to one or more 4D browsers 30, described in FIG. 4 below. 4D portal databases 1 may reside on the same computing system as the 4D server 25, or on a remote computing system accessed by the 4D server 25 via a network connection. Computing systems, including 4D servers and remote 4D user computer workstations, preferably include processors, processor readable media (e.g., drives, random access memory, read only memory, or the like), network interfaces, displays, and input devices (e.g., keyboards, mice, trackballs or the like). For a single user system, the 4D browser 30 may also reside on the 4D server 25 computing system, although the preferred embodiment comprises multiple 4D browsers 30 residing on remote 4D user computer workstations 41 communicating with the 4D server 25 via a network connection. Both the 4D browser GUI 30 and 4D browser render window 40 may reside on the same 4D user computer workstation 41, but, as described in FIG. 4 below, with the preferred embodiment comprising a network transmission between the 4D browser GUI 30 and the 4D render windows 40, they may also reside on separate 4D user workstations 41, either locally or remotely connected via a network. Multiple 4D render windows 40 on remote 4D user computer workstations 41 may also communicate with a single 4D browser GUI 30. Individual components are described in detail below.

Referring now to FIG. 2, there is shown a flow diagram of a prior art method to transform information databases into 4D portals. The method produces a 4D portal database 1 from any information database 16.

The method begins with the 4D administrator 20 identifying a set of 4D object types 10. This is accomplished by first reorganizing and extracting data subsets from an information database 16 that contains data representable by a 3D visual object model 3, including real world physical entities as well as visual models for more abstract datasets representing items such as environmental noise, for example. These data groupings represent the candidate 4D object types 10. Those data groupings that are static in nature, that is, have a fixed number of instances and no data values that change over time, become part of the 4D portal world model 23, and are removed from the list of 4D object types. Based on the decision support requirements 22, provided to the 4D administrator by management, for which the 4D portal 1 is being built, the 4D administrator 20 may also remove 4D object types 10 that are of no apparent interest to management. The 4D administrator 20 may also organize the 4D object types 10 into a 4D object spatial hierarchy 13, such as buildings that contain floors, to provide for a spatial resolution drill-down capability in the 4D portal 1.

Those data values of each 4D object type 10 dataset that change over time in the information database 16, including its associated database update archive 17, are identified by the 4D administrator 20 as 4D object attributes 11, which definition maintains the link back to its representative data field in the information database 16. The 4D administrator 20 also evaluates the list of 4D object types 10 for inter/intra-dependencies, that is, actions taken by one 4D object type that has an effect on another, such as a vehicle object moving a container object to another location, or on itself, such as inserting a new instance of this 4D object type. These actions are defined in a list of 4D object actions 12. 4D object actions 12 are grouped in temporally opposite pairs, such as insert:remove, attach:detach, start moving from point a: arrive (stop) at point b, for example, which make the actions temporally reversible.

The 4D administrator 20 defines a set of potential spatial manifestations 9 for each 4D object attribute 11 and 4D object action 12. The set of available spatial manifestations are defined by the visual capabilities of the 3D graphics scene graph rendering engine implemented in a preferred embodiment of the 4D browser system described in FIG. 4., and includes, but is not limited to, color, color ramp, scale, XYZ translation or articulation, guideway translation or articulation, HPR and guideway orientation, texture file mapping, lighting/shadows, temporal fade, translucency and shape. The ability to affect these visual manipulations with 4D portal data is achieved by this method of defining these spatial manifestations 9.

The 4D administrator 20 gathers the 4D object types definitions 10 organized in a 4D spatial hierarchy 13, 4D object attributes definitions 11, 4D object actions definitions 12 and spatial manifestation definitions 9 into a set of 4D object definitions 2. The preferred embodiment of these 4D object definitions 2 is a human-readable meta-data format, such as ASCII, defining 4D object parameters gathered together into one definition format.

For every 4D object type 10, the 4D modeler 21, or a group of 4D modelers, utilizing a 3D realtime visual model generator 18 toolkit such as MultiGen® Creator, builds a representative 3D geometric visual model 3 of the object. The 4D modeler 21 also builds a 4D portal world model 23 representing the static visual scene that the 4D object visual models 3 are rendered in by the 4D browser. Preferably, each 4D object visual model 3 is defined with a spatial location referenced to this 4D portal world model 23 scene graph, and becomes a sub-graph component of this 4D portal scene graph.

The 4D modeler 21, utilizing a guideway generator 19 toolkit such as MultiGen® RoadTools, creates guideway definitions 4 for the defined set of potential spatial manifestations 9.

The 4D administrator 20 takes the current information database 16, available database update archives 17, and the set of 4D object definitions 2, and processes them through a 4D audit trail generator 15 to create the 4D audit trail 14. The 4D audit trail 14 includes time-stamped records for every instance when a 4D object 2 instance performs a 4D object action 12 or has a change in one of its 4D object attributes 11, which can be derived from the identified set of source data via difference checking. For 4D object actions, there is an associated end action, such as destroy or stop motion, for example, for each begin action, such as create or start motion, respectively. The database update archive 17 may be a set of historical snapshots of the information database, or may include daily backup/recovery audit trails that are generated by the associated database management system which aids in the audit trail generation and increases its temporal resolution.

The 4D audit trail generator may be a manual procedure, but since it will likely be done on a regular basis to keep the 4D audit trail 14 current, its preferred embodiment comprises a database scripting language batch job and/or a customized computer program to automate the procedure.

The 4D audit trail 14, together with the 4D object definitions 2, 4D portal world visual model 23, 4D object visual models 3 and guideway definitions 4 are gathered into a 4D portal database 1 which is accessed by the 4D server. In its preferred embodiment, this 4D portal database 1 is implemented in a relational database management system, such as Oracle.

The 4D administrator 20 is preferably responsible for more than one 4D portal database 1. Although the complete method described in FIG. 1 may be a manual procedure, its preferred embodiment includes utility computer programs that assist the 4D administrator 20 in creating and maintaining a 4D portal database 1.

Referring now to FIG. 3, there is shown a flow diagram of a prior art operation of the 4D server in the system. The 4D server accepts 4D browser requests 6 from multiple 4D browsers, described in FIG. 4 below, and generates appropriate 4D server responses 7 back to the 4D browsers. This function is performed by the 4D server program 25, which in its preferred embodiment is a Java™ servlet computer program interfaced to a web server, such as Apache. Although any network protocol may be utilized to receive 4D browser requests 6 and transmit 4D server responses 7, the preferred embodiment allows for these requests and responses to be encapsalated in HTTP message packets received and transmitted by the front-end web server locally interfaced to the 4D server program 25.

The 4D server program 25 generates appropriate responses for 4D browser requests 6 by accessing the specific 4D portal database 1 identified in the 4D browser request. Multiple 4D portal databases 1 may be accessible through a single 4D server. In its preferred embodiment, the 4D server program 25 accesses 4D portal databases 1 utilizing the java JDBC™ interface, allowing 4D portal databases 1 to be resident locally on the same computer as the 4D server program 25, or on a remote computer system accessible over a network. The 4D browser requests 6 processed by the 4D server program 25 include, but are not limited to, open, close, query, object selection and update.

In response to an open request, the 4D server program 25 extracts and transmits the 4D portal definition 26 from the specified 4D portal database 1. 4D portals may be access protected; if so, the access password contained in the open request is verified before access to the specified 4D portal database 1 is permitted. The 4D portal definition includes 4D object definitions 2, 4D portal world visual model 23, 4D object visual models 3 and guideway definitions 4 (all shown in FIG. 2). The 4D server program preprocesses guideway definitions, augmenting the definition with an ordered list of segment lengths before including them in the 4D portal definition 26. Static 4D portal data, such as the large visual model dataset, may be distributed locally to 4D browser users on CDROM or other media for local storage. The open request specifies 4D portal data components to be loaded locally to reduce the transmission size of the 4D server response 7. The open request is designed to proceed all other browser requests on a specific 4D portal database. When the 4D server program 25 receives a close request, it accepts from the specific 4D browser system a new open request on a different 4D portal database 1.

In response to a query request, the 4D server program 25 generates and transmits a set of 4D object states 5. This set is preferably generated as follows: The SQL selection statements contained in the query request is executed against the 4D audit trail 14 contained in the 4D portal database 1 to create a result set. This result set is then binned according to the maximum temporal and spatial resolutions specified in the query request. The bins are then sorted by 4D object, in time order. The resulting ordered list is then scanned and, for 4D object attribute entries, each time-stamp is stretched into a time frame inclusive of any time gap preceding the next time stamp for that attribute. For 4D object action entries, they exist in begin-end pairs, such as create-destroy or start motion-stop motion. During the scan, each action pair is combined into one object state for the specified begin-end time frame. This results in the set of 4D object states 5 transmitted as the 4D server response 7. In an alternate embodiment, the 4D server program 25 responds with a 4D server response 7 containing the initial result set, with the 4D browser described below performing the binning and time frame processing.

In response to an update request, 4D object definition values or object state time frames contained in the 4D browser request 6 are exported by the 4D server program 25 to a local external update file 27. If an update file is specified in an open request, any 4D object definition changes contained in the specified update file 27 are applied to the 4D portal definition 26 transmitted as the 4D server response 7. Similarly, if an update file is specified in a query request, any 4D object state time frame changes contained in the specified update file 27 are applied to the 4D object states 5 transmitted as the 4D server response 7.

In response to an object selection request, the 4D server program 25 generates and transmits a web browser displayable page 8 of information about the selected 4D object that is temporally accurate for the specified time stamp. This is achieved by the 4D server program 25 scanning the 4D object states 5 last transmitted to the requesting 4D browser for current object attribute and action states for the specified time. The web page 8 is created utilizing web page techniques, such as HTML or XML. The content of the web page 8 may be anything, but its preferred embodiment includes attribute values and raw 4D audit trail 14 entries represented by any binned current object states.

Referring now to FIG. 4, there is shown a flow diagram of a prior art operation of the 4D browser in the system. The two main components of the 4D browser are the 4D browser GUI 30 and the 4D browser render window 40, which in their preferred embodiments are separate computer programs with a data interface implemented with network protocols. The render window 40 may execute on the same or different machine as the 4D browser GUI 30, but for effective interactive visual graphics rendering preferably executes on a computer with a 3D-hardware-accelerated graphics subsystem. The 4D user 41 begins the execution of both these programs locally, and interacts with them via the local keyboard and a cursor control device 39 such as a mouse, joystick or trackball.

The 4D browser GUI 30 provides the 4D user 41 with a set of screen GUI widgets, such as buttons, sliders, choice and list boxes, which enables the 4D user 41 to generate 4D browser requests 6 which were described above in FIG. 3, as well as view and optionally modify 4D portal data received via 4D server responses 7, such as 4D object definitions 2, spatial manifestations 9 and 4D object states 5. In its preferred embodiment, the 4D portal model 31 and 4D object visual models 3 in the 4D browser GUI 30 are filename references to local data files that maintain the specific scene and model geometry specifications. All updates to any data value in the 4D browser GUI 30, either by the 4D user 41 or 4D server responses 7, is immediately accessible by the render window 40. One embodiment to accomplish this is via a shared memory segment, although the preferred embodiment communicates data updates via network protocols over the data interface to the active render window 40.

The 4D browser GUI 30 also allows the 4D user 41 to manipulate global view settings 35, such as render mode (wireframe or surface), enabling textures, sun position, viewpoint XYZHPR location, selected viewpoint motion mode, for example, which are utilized by the render window 40 to control attributes of the rendered graphics scene on the computer screen. The viewpoint location is also moved by the 4D user 41 in all three spatial dimensions via the use of the cursor control device 39 in the render window 40.

The 4D browser GUI 30 also displays web pages received via a 4D server response 7, either by reference to a webpage filename on the 4D server computer system or by a stream of webpage directives, such as HTML. In its preferred embodiment, it does this by executing a web browser program on the 4D user's 41 computer workstation.

The 4D browser GUI 30 also provides the 4D user 41 with a special time controller widget to interactively control the fourth dimension of time by manipulating the selected render time 32 value. The preferred embodiment of the time controller includes a slider bar to manually move time forward or back, time resolution choice selection, and forward, reverse, pause and record buttons similar to that on a VCR for automatic time updates. The record feature activates a global view setting 35 that causes the render window 40 to save its rendered visual scene to a local disk image file each time it is updated.

The 4D browser render window 40 graphically renders the temporally current 3D visual scene, viewed by the 4D user 41 at the current spatial viewpoint location, representing the present 4D portal manifestations in all four dimensions. In its preferred embodiment the render window 40 computer program executes a scene graph render loop, such as that contained in Java3D™ or SGI's Performer™, augmented by specialized 4D functionality described below, that displays an interactive 3D visual scene in the screen render window. The scene graph 37 includes the 4D portal world visual model 31, as well as numerous sub graphs for each current 4D object instance 33 containing the geometry of the specified 4D object visual model 3.

The preferred embodiment of the render window 40 computer program is a free-running render loop that performs the following functions: If the selected render time 32 changes, the new current 4D object state 34 for each 4D object instance 33 is identified by scanning the temporally-ordered list of 4D object states 5, either backwards or forwards depending on which direction time was moved, beginning with the previous current 4D object state 34, finding the 4D object state 5 whose time frame contains the new selected render time 32. If through the 4D browser GUI 30 the time-frames of any 4D object states 5 were modified, the above selection process is also done, but may be limited to the 4D object instances 33 affected by the modification.

The specified spatial manifestations 9 are then processed for each current 4D object state 34, as well as any 4D object states 5 that were skipped over in the above selection process, in time order to maintain temporal context of the 4D object states. The processing of spatial manifestations 9 may create/remove 4D object instances 33 whose subgraph would also be inserted/deleted from the scene graph 37, or may affect the visual appearance or location/orientation of the 4D object visual models 3 of existing 4D object instances 33 via geometric/visual transformations 36 to the scene graph 37. More details of spatial manifestation processing is described below.

The render window 40 render loop activates the current global view settings 35, and culls scene graph 37 subgraphs that are outside the viewing frustrum specified in the global view settings 35, or whose associated 4D object has been visually deactivated by the 4D user 41 via the 4D browser GUI 30. The geometry contained in the remaining active scene graph 37 is rendered relative to the current viewpoint location into the graphics engine of the computer workstation for visual display to the 4D user in the screen render window 40.

Spatial manifestations 9 of 4D object states 34 may take numerous forms. Embodiments of spatial manifestations effect changes to the scene graph 37, either via geometric/visual transformations 36 to the 4D object instance 33 subgraph containing the 4D object visual model 3, or by inserting/removing a subgraph containing a 4D object visual model 3 for a new/old 4D object instance 33. The preferred embodiment includes spatial manifestations 9 for visual techniques supported by the underlying scene graph rendering graphics API, including, but not limited to, static color change, progressive color ramp, static or progressive object scale factor, orientation, translation, articulation, texture image application, translucency and object shape. In addition, the preferred embodiment supports special 4D techniques including progressive temporal fade in/out and guideway translation, described below. An alternative embodiment effects certain spatial manifestations, such as color or scale, which are supported by the underlying graphics API with immediate mode graphics commands in node callback routines which are processed as each subgraph is reached in the scene graph traversal during the drawing process. This embodiment does not directly modify the scene graph 37, so spatial manifestations 9 using this technique are effected each time the render window 40 is updated.

Spatial manifestations of the progressive nature define a visual effect over a specified range, such as movement from point a to b, color from light red to dark red, or scale factor from 4 to 8, for example, which are processed in direct proportion to the percent value that the selected render time 32 falls within the current 4D object state's 34 time frame associated with this spatial manifestation 9. Multiple spatial manifestations 9 may be active for any given current 4D object state 34.

The temporal fade out special spatial manifestation 9 is processed as a visual transformation 36 which affects the spatial level-of-detail fade range of the associated 4D object visual model 3 scene graph 37 subgraph. The ratio of the fade range to the current distance of the 4D object model 3 from the viewpoint is in reverse proportion to the fractional percentage value that the selected render time 32 falls within the current 4D object state's 34 time frame associated with this spatial manifestation 9. For a temporal fade in manifestation, the remaining time frame fractional percentage is used.

The guideway translation spatial manifestation 9 is processed utilizing the 4D portal guideway definitions 4 to manifest a 4D object model's 3 motion path in the scene. The preferred embodiment of geometric transformations 36 of the motion nature is via a dynamic coordinate node in the appropriate scene graph 37 subgraph representing the 4D object visual model 3, allowing the model to be located anywhere and in any orientation in the scene. The preferred embodiment includes a default linear motion profile over the entire specified guideway length over the duration of the associated current 4D object state's 34 time frame. Simple motion manifestations from point a to b have an implied single segment line guideway to follow. Additional motion parametrics may be specified to effect different motion profiles, such as acceleration or constant speed, for example, during different periods of the time frame. Using these parameters the distance traveled from the beginning of the guideway relative to the fractional percentage value that the selected render time 32 falls within the current 4D object state's 34 time frame associated with this spatial manifestation 9 is calculated. Using the 4D portal guideway definition 4 data, the current guideway segment and the 4D object visual model 3 offset into this segment is identified for the calculated distance traveled. A linear interpolation between the segment endpoint XYZHPR values yields the current manifested 4D object model 3 XYZ location and HPR orientation in the scene, which are used to transform the appropriate scene graph 37 subgraph's dynamic coordinate node.

The 4D user 41 may, through appropriate global view settings, place the cursor control device 39 of the render window 40 in motion mode or picking mode. Various motion modes are available to the 4D user 41 representing a variety of motion control models that are included in the embodiment of the render window. In motion mode, manipulating the cursor control device 39 moves the render viewpoint location to a new XYZHPR location in accordance with the active motion control model. In picking mode, the cursor control device 39 is used to select a 4D object instance from the visual scene and either spatially relocate it, or generate a 4D browser object selection request 6 through the 4D browser GUI 30. A 3D picking algorithm is used, such as a line-of-sight ray intersection calculation, to identify the selected 4D visual model 38, which is identified by its scene graph subgraph as a specific 4D object instance 33 which can be spatially repositioned in the scene graph 37 or made part of an object selection 4D browser request 6.

As a simple example, consider an online information database of a food store operation, where the manager needs a better understanding of the store operation to improve efficiency and increase sales. A 4D portal into this information database could define grocery items, shelf units and customers as 4D objects. The 4D portal world rendered by the 4D browser includes a 3D model of the store interior in which shelf units and the grocery packages they contain are situated. The 4D world could also extend as a 3D map of the local community to visualize customer homes and visually track the groceries they purchase. The 4D audit trail is populated with events every time the online database is updated when a grocery item barcode is registered at the checkout counter by a customer, identified by their credit card information, as well as stockboy actions to replenish grocery items on the shelf locations and new grocery deliveries received in the stockroom. The 4D server can generate 4D object states representing the movement of grocery items from the stockroom to the shelves and eventually to customer homes. The store manager can use the 4D browser to analyze the movement of grocery items as it progresses over time to gain an understanding of his customer's buying habits as it relates to grocery items, shelf locations and quantities relative to other grocery items, relative proximity and customer ease of access to the store, time of day, household types and sizes, and so on, which can help effect operational modifications to the store operations to better serve and expand its customer base, improving efficiency and increasing sales. This example is provided to augment the previous description with a brief real world application.

Accordingly, known systems enable a 3D/4D object that is visualized and geo-referenced in a 3D/4D world, and rendered in a 4D browser. Moreover, hierarchical 3D/4D objects, such as buildings containing floors, containing offices, and so on are known. Furthermore, spatial manifestations of 3D/4D objects, including wireframe, color and translucency, which may be useful for viewing inside a 3D object, such as a building, are also known. Such spatial manifestations of 3D/4D objects, however, may result in obstructed views at some, if not all, viewing angles. Additionally, systems are known for the picking and spatial relocation of 3D/4D objects, as well as the tracking of a 4D object's spatial location over time.

Notwithstanding the above-described advancements in 3D/4D computer graphics, the prior art does not teach or suggest a completely unobstructed view inside of 3D/4D object models, such as buildings.

### SUMMARY

Is desirable and useful to improve situation awareness when viewing hierarchical 3D/4D object models, such as multi-floor buildings. Accordingly, the teachings herein provide an ability to spatially stretch a 3D/4D object hierarchy so that each individual component of the 3D/4D object hierarchy, such as individual building floors and corresponding detailed contents, are sufficiently spaced apart so they can be viewed without any visual obstructions, and yet still have their actual geo-location logically maintained. The teachings herein enable users to effectively develop situation awareness by having an unobstructed view into a specific location within a 3D/4D object model, such as a floor of a building.

In accordance with the teachings herein, effective decision support tools are provided that improve situation awareness, for example, in the fields of security, law enforcement and emergency response. Computer-based visualization tools are preferably utilizable to develop dynamic situation awareness at a specific geo-location.

In a preferred embodiment, the spatial hierarchy of a set of 3D/4D object models in a 3D visual scene is visually stretched to improve the visibility of the 3D/4D object model components of the spatial hierarchy, while logically maintaining geo-positioning. The ability to interactively spatially stretch a hierarchical 3D/4D object model, such as a multi-floor building as a non-limiting example, provides unobstructed viewing of internal contents, including but not limited to all infrastructure, cameras, sensors and dynamic object tracks.

Moreover, a hierarchical 3D/4D object model is interactively rendered to spatially stretch the model in any or all three dimensions of space, while maintaining the logical geo-location of each object component. Moreover, the input and transformation of a hierarchical 3D/4D object model is preferably provided into a stretchable structure.

Preferably selectable user interface controls are provide that, when selected, interactively manipulate the stretching and rendering of hierarchical 3D/4D object models.

Further, real-time sensor data that are geo-located within a hierarchical 3D/4D object model, such as via surveillance camera feeds and dynamic tracking reports (as two non-limiting examples), are preferably provided as input and for rendering the sensor data at the proper geo-location on a spatially stretched hierarchical 3D/4D object model.

Other features and advantages will become apparent from the following description that refers to the accompanying drawings.

### BRIEF DESCRIPTION OF THE DRAWINGS

For the purpose of illustration, there is shown in the drawings a form which is presently preferred, it being understood, however, that the invention is not limited to the precise arrangements and instrumentalities shown. The features and advantages will become apparent from the following description that refers to the accompanying drawings, in which:

FIG. 1 is a block diagram of prior art system components in accordance with a preferred embodiment;

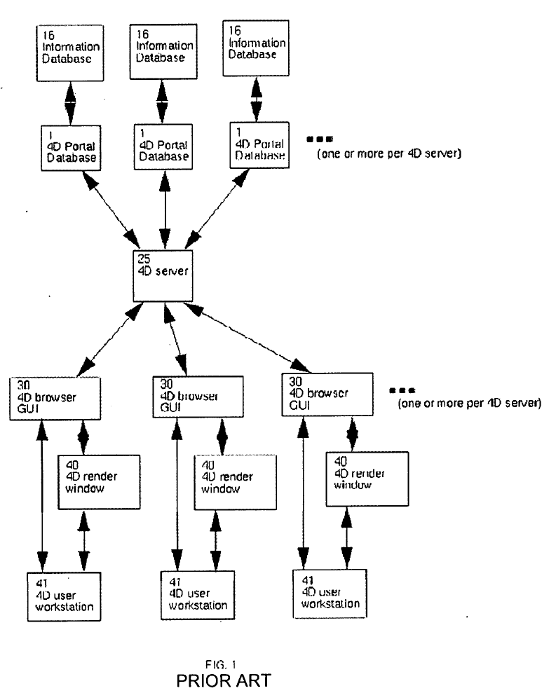

FIG. 2 is a flow diagram of a prior art method to transform information databases into 4D portals in accordance with a preferred embodiment;

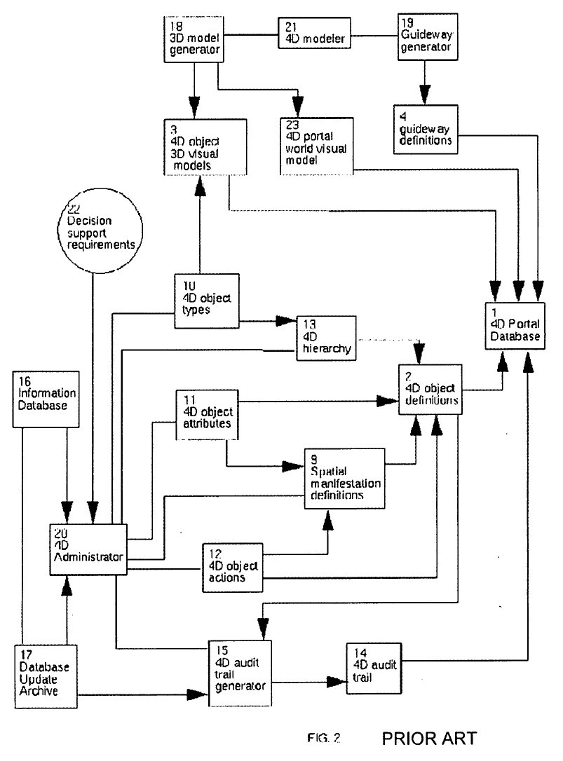

FIG. 3 is a flow diagram of a prior art operation of the 4D server in accordance with a preferred embodiment;

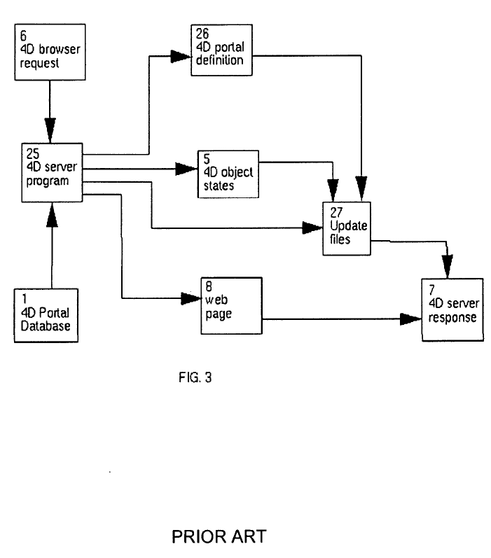

FIG. 4 is a flow diagram of a prior art operation of the 4D browser in accordance with a preferred embodiment;

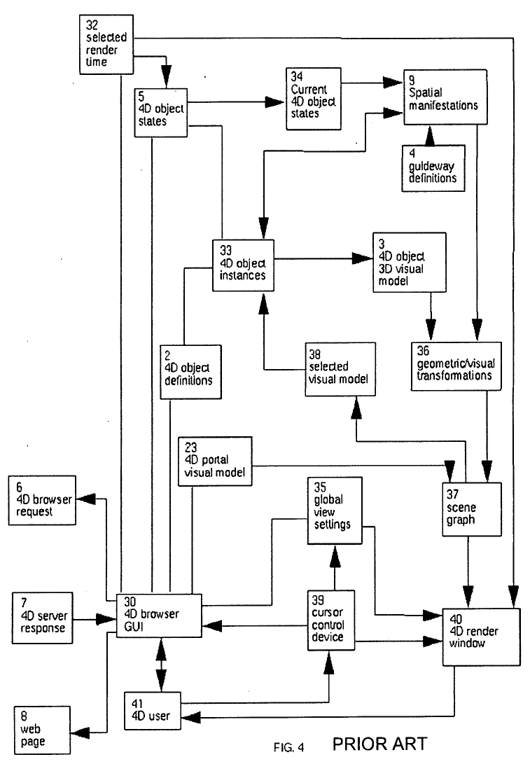

FIG. 5 is a block diagram of the components of the method in accordance with a preferred embodiment;

FIG. 6 is a flow diagram of the method component transforming hierarchical 3D/4D object model components in accordance with a preferred embodiment;

FIG. 7 is a flow diagram of the method component transforming user interface controls in accordance with a preferred embodiment;

FIG. 8 is a flow diagram of the method component transforming geo-referenced data feeds in accordance with a preferred embodiment;

FIG. 9 is a view of an example 3D/4D viewer display showing an interactive rendering of an unstretched hierarchical 3D/4D object model of a building with floors in accordance with a preferred embodiment; and

FIG. 10 is an example view of a 3D/4D viewer display showing an interactive rendering of a stretched hierarchical 3D/4D object model of a building with floors in accordance with a preferred embodiment.

### DESCRIPTION OF THE EMBODIMENTS

In the field of 3D/4D computer graphics, a system and method is disclosed for visually stretching the spatial hierarchy of a set of 3D/4D object models in a 3D visual scene to improve the visibility of the 3D/4D object model components of the spatial hierarchy while logically maintaining each respective object model component's geo-positioning. In order to describe features of the teachings herein, various examples are provided, such as relating to building structures. It is to be understood that the examples provided herein to describe the embodiments are meant to be non-limiting, and that other examples are envisioned without departing from the spirit and scope of the teachings herein.

In accordance with the teachings herein, hierarchical 3D/4D object models are interactively stretchable in a 3D/4D virtual scene. In one preferred embodiment the hierarchical 3D/4D objects can be interactively stretched within the context of a 3D or 4D viewer computer program, which, as noted above, provides for rendering and user interaction with a computer-generated virtual scene. Examples of such viewer computer program include OSGVIEWER and FOURDSCAPE.

Preferably, a user is provided with the ability to spatially stretch hierarchical 3D/4D object model components, such as floors of a building and their contents, in any direction, for example, vertically, horizontally, diagonally, or the like, simply by using a computer interface point-and-click device, (e.g., a mouse, track ball or other pointing device). For example, a user uses a computer mouse to select a particular floor of a 3D/4D building model, and then to “drag” the selected floor horizontally, similar to opening up a dresser drawer, or even vertically to create space between the floor and the floor below it. Continuing with this example and in a preferred embodiment, the floor(s) above the selected floor also move(s) up vertically along with the spatially dragged floor. Accordingly, every floor of a building can be dragged and spaced apart sufficiently to allow for, for example, unobstructed viewing into the entire contents of each floor. In another example, the mouse-wheel is useable by the user to spatially stretch a plurality of floors of a building model simultaneously, at the same time, thereby creating an appearance of a tower of floors that is spaced vertically.

As each hierarchical 3D/4D object model component, such as a floor of a building and related contents, is spatially relocated, all the hierarchical sub-components of the floors, such as infrastructure, cameras, sensors and dynamic object tracks as non-limiting examples, are also automatically relocated to the new spatial floor position, and the original, actual geo-location of all components are logically maintained.

In a preferred embodiment, geo-referenced real-time sensor data feeds are provided with a 3D/4D viewer containing the stretched hierarchical 3D/4D object model. For example, sensor data including surveillance camera feeds and alarm status data can be geo-located at respective hierarchical 3D/4D object model sensor component locations, such as on a floor. This enables the respective hierarchical 3D/4D object components (e.g., on a floor) to be stretched substantially automatically, along with the floor to be visually depicted at the stretched location. This same visual effect can also be achieved with any geo-referenced data feed, including but not limited to real-time object tracks, such as GPS, GMTI and RFID track data being non-limiting examples, as well.

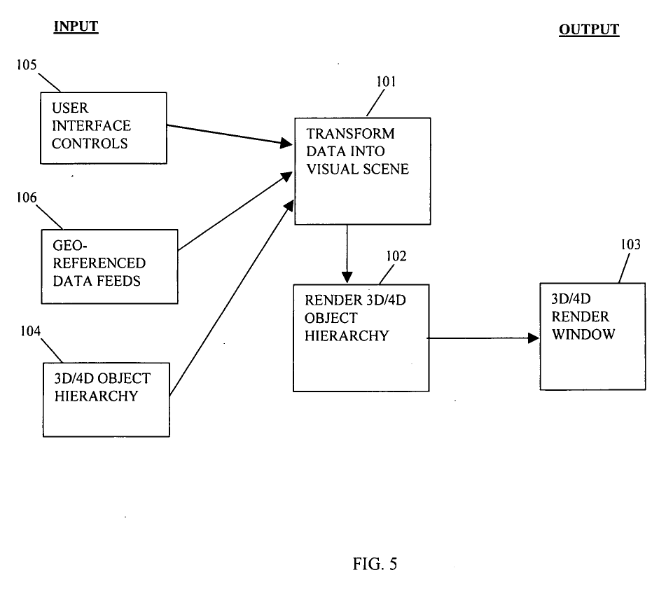

Referring now again to the drawings, there is shown in FIG. 5 a block diagram illustrating steps associated with a preferred embodiment. Various types of input 104, 105, and 106 are received and transmitted to a receiving device, such as a processing device, and used to transform the received data into a visual scene (step 101). The data are rendered (102), and a complete 3D/4D object hierarchy output is provided to the user displayed in a render window (103).

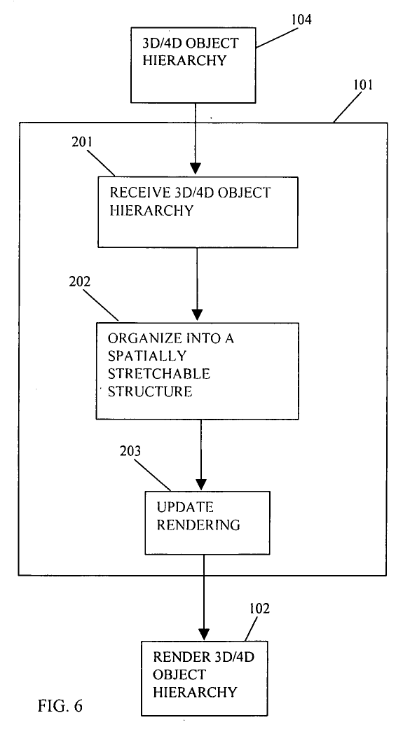

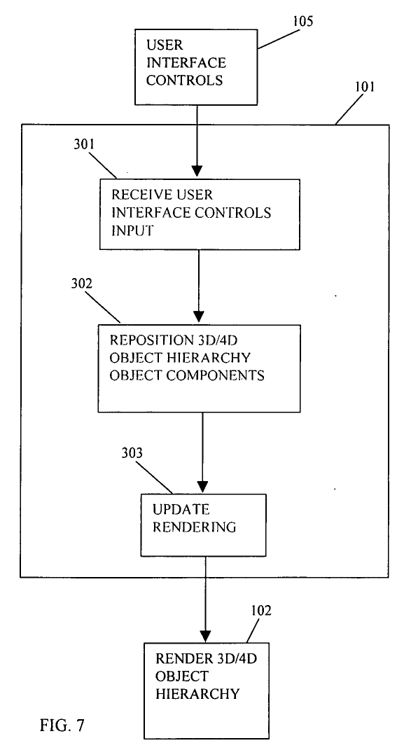

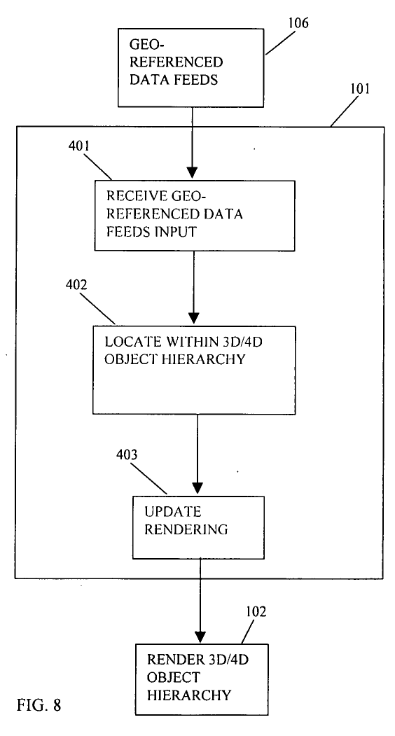

The processing and transformation of each of the various inputs 104, 105, and 106 are described in FIG. 6, FIG. 7, and FIG. 8, respectively.

In FIG. 5, transforming 101 the input data results in a 3D graphical rendering 102 of the 3D/4D object model and all its component hierarchical objects in a computer-generated visual scene. In a preferred embodiment, the computer-generated visual scene takes the form of a scene graph. This resulting scene graph, such as OPENSCENEGRAPH being one such non-limiting example, is then rendered 102 into a low level graphics language, such as OPENGL being one such non-limiting example. The scene graph rendering is preferably processed by at least one of a variety of computer graphics cards, such as provided by NVIDIA, and displayed to the user as an interactive 3D graphical display in a render window 103 on a computer display screen (e.g., a flat panel display or a handheld device).

Referring now to FIG. 6, there are shown additional steps in a flow diagram associated with the processing and transform 101 of the 3D/4D object hierarchy input data 104. The 3D/4D object hierarchy definition input 104 is preferably received 201 by the method transform component 101. In one example in accordance with a preferred embodiment, consider a 3D/4D object model of a multi-story building. The building model is transformed by organizing it into a spatially stretchable structure 202, which is preferably accomplished by organizing each hierarchical building model component into a local child subgraph within the scene graph, and defining spatial neighbor components for each subgraph. This method transform component 101 can be executed once for a single 3D/4D object hierarchy input 104, or multiple times for many individual 3D/4D object hierarchy inputs, or incrementally to dynamically include additional 3D/4D object hierarchy components to an already transformed 3D/4D object model hierarchy. With the scene graph organized into appropriate subgraphs, in accordance with the teachings herein, the rendering of the 3D/4D object hierarchy is updated 203 and rendered for the user to view interactively 102.

Continuing with the non-limiting example regarding a multi-story building model, each floor graphical model is preferably organized into its own self-contained local subgraph in the scene graph. Respective floor components, such as walls, doors, windows, are graphically positioned in a subgraph relative to a local floor coordinate system originating at a specific known location on the floor, such as at the center or a corner. Each local floor subgraph can then be positioned at its proper location relative to the entire building model, which is preferably achieved by placing a matrix transform at the top of each subgraph to translate the local floor coordinate system into the building coordinate space. These component hierarchy subgraphs may be generated for a large number of hierarchy levels, if desired.

Other individually geo-referenced hierarchical object components, such as alarms, sensors and surveillance cameras being non-limiting examples, may be included in the hierarchy by including each of them as a component subgraph to the appropriate floor subgraph.

Spatial neighbor components are also preferably defined for each subgraph, which are utilized to move neighboring components visually out of the way when stretching the model. For example, floors subgraphs in a simple multi-story building model may include a floor below and a floor above as respective spatial neighbors, thereby creating a spatial neighbor chain that is preferably used to logically stretch out building model components at any hierarchy level.

Referring now to FIG. 7, there is shown a flow diagram of steps associated with the processing and transform 101 of data received from user interface controls input data 105. The data received from user interface controls input 105 are preferably received 301 by the method transform component 101. In addition to other known 3D/4D graphical user interface controls, such as wireframe, translucency and eyepoint motion controls being non-limiting examples, input from the user controls 301 are preferably received and used to visually stretch a 3D/4D object model hierarchy by repositioning 3D/4D object hierarchy components in the visual scene. In one preferred embodiment, the user utilizes a pointing device, such as a mouse, trackball or the like, and selects a specific 3D/4D object model hierarchy component (e.g., a floor of a building) and spatially drags the 3D/4D object model hierarchy component to a new position. Continuing with the multi-floor building example, dragging a floor vertically preferably repositions 302 the selected floor and all the floors above it to a new, higher vertical position, exposing the floor below it for an unobstructed view by the user. In a preferred embodiment, this is accomplished by modifying the matrix transform of the floor subgraph in response to the user interface controls input, as well as by modifying the matrix transforms of the spatial neighbors subgraphs in the spatial neighbor chain above it by the same amount.

In one preferred embodiment, the user can use a mousewheel or trackball to spread out a complete spatial neighbor chain of components simultaneously, such as vertical floors in a building, increasing or decreasing the visual space between every floor to provide unobstructed viewing. In yet another embodiment, the user can use 2D/3D graphical user interface widgets, such as vertical and horizontal sliders, to achieve the same.

Although various 3D/4D object hierarchy component subgraphs can be repositioned in a visual scene by a user, each subgraph's original, real world geo-position is preferably stored in a memory for future reference. For example, a user interface control input is usable to drag or “snap” components back to their original, real world positions. In a preferred embodiment, components that are connected in the spatial neighbor chain are relocated by the same spatial distance as one original component that was snapped back to its original location.

In case data are received 301 in connection with a new user interface control 105 and processed 302, the rendering of the 3D/4D object hierarchy is preferably updated 303 and rendered for the user to view interactively 102. In addition, as a user moves the user interface control (e.g., via a mouse or trackball), hints may be overlaid on the scene identifying and providing other known attributes of the current 3D/4D object hierarchy component subgraph being pointed at, which in a preferred embodiment can be determined by a bottom-up scene graph ray intersection test with the subgraph geometry or bounding box.

Referring now to FIG. 8, there is shown a flow diagram of steps associated with the processing and transform 101 of the geo-referenced data feeds input data 106. In the example shown in FIG. 8, the geo-referenced data feeds input 106 is received 401 by the method transform component 101. Geo-referenced data feeds are, typically, real-time and dynamic in nature and may take on many forms, such as surveillance camera image streams, alarm status reports, and location reports of tracking devices.

Some geo-referenced data feeds may be associated with known, static components of a 3D/4D object hierarchy, already existing as a component subgraph in the object component hierarchy scene graph, such as mounted cameras and alarms within a building. These types of geo-referenced data feeds 106 can be located 402 and associated with a specific component subgraph by attribute, such as ID being a non-limiting example, or original real-world location matching of the data stream meta-data with the appropriate 3D/4D object hierarchy component and its subgraph. The subgraph may then be updated 403 with the current geo-referenced data report, such as the latest camera image or alarm status. Since the component subgraph is already a part of the 3D/4D object hierarchy, it is preferably rendered 102 at the appropriate stretched repositioned visual location, or original real-world location if it has not yet been stretched by the user.

Moreover, some geo-referenced data feeds may be associated with new components that are dynamically introduced within a 3D/4D object hierarchy, such as emergency responders wearing geo-tracking devices and mobile cameras entering a building. These types of geo-referenced data feeds 106 are located 402 and associated with a specific 3D/4D object hierarchy component by comparison of the geo-referenced data's current geo-location with a bounding area of each subgraph of components in the 3D/4D object hierarchy relative to their original, real-world position to determine within which it currently lies. Once this is determined, the geo-referenced data's current real-world location can be translated into the local coordinate space of the specific component subgraph and a representative model, such as a cone, pin, bar or avatar being non-limiting examples, can be added to update 403 the specific component subgraph, positioned relative to the component local origin. This new geo-referenced data representative model will then be rendered 102 at the appropriate stretched repositioned visual location, or original real-world location if the 3D/4D object hierarchy component it currently exists within has not yet been stretched by the user.

As a non-limiting example, consider one or more emergency responders wearing tracking devices entering a building, which is visually represented as a stretchable 3D/4D object model hierarchy. As each real-time geo-referenced data feed reports each new responder's current position, it is determined which floor each is currently on, and a representative avatar may be preferably included in that floor's object hierarchy component subgraph. Each previous responder's position's representative model can be visually modified each time, such as making it smaller or changing its color, to represent a metaphorical bread crumb depicting previous location tracks. As the user stretches out the floors of the building to see an unobstructed view of each specific floor, the emergency responders tracks are accurately maintained and follow each floor accordingly as each floor is visually repositioned to a new stretched location.

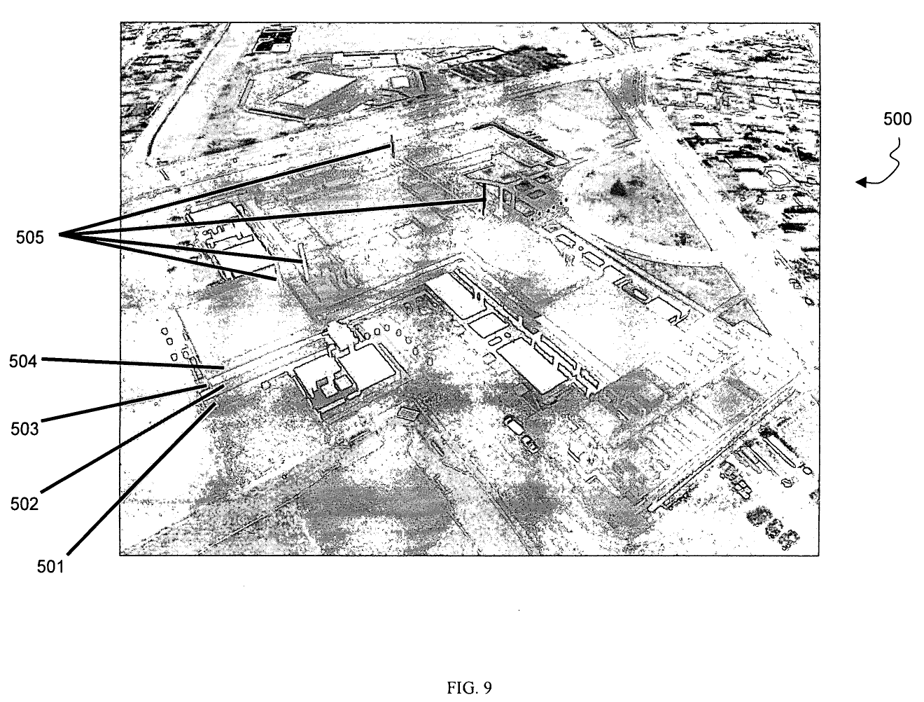

Referring now to FIG. 9, there is shown an example display screen image 500 within a 3D/4D render window to provide a visualization example of the method according to a preferred embodiment. Seen on the aerial photo is a four story building transformed according to the method as a stretchable 3D/4D object model hierarchy. It has four floor components, 501, 502, 503 and 504. In this unstretched form, only the top floor 504 has an unobstructed view. There are a number of vertical bars 505, which are preferably colored (not shown), depicting the current location of emergency responders, but it is visually unclear here which floor they are on.

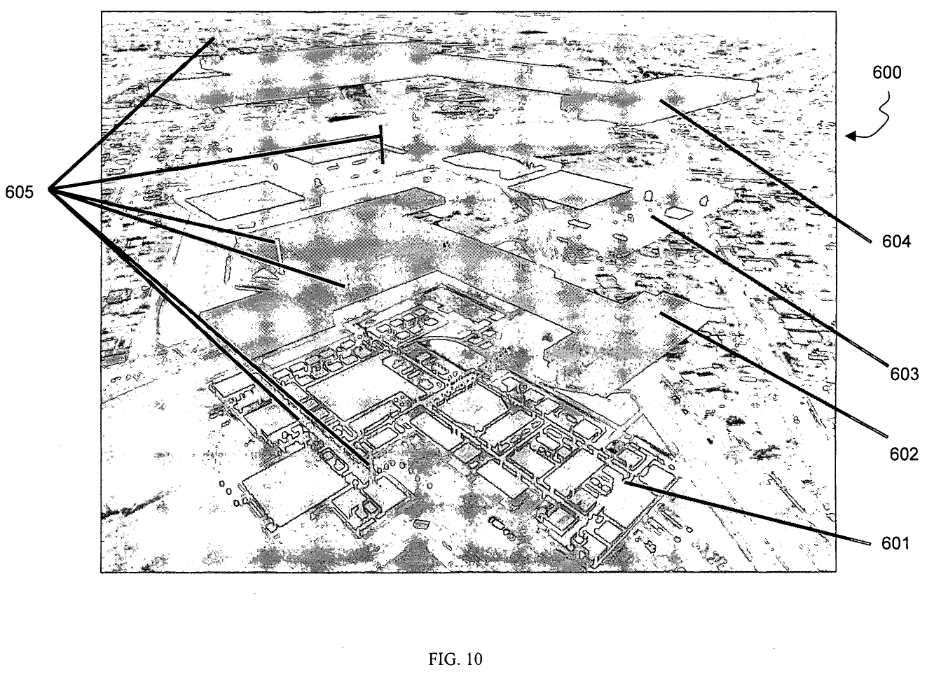

Referring now to FIG. 10, there is shown the building depicted in FIG. 9 within a 3D/4D render window 600. In the example display screen shown in FIG. 10, the user has stretched the building model out vertically so there is sufficient separation between each of the four floors 601, 602, 603 and 604 that the user can move their eyepoint and fly in for an up-close, unobstructed view of any floor and its contents. In this stretched form, the numerous vertical bars 605, which are preferably colored (not shown), depicting the current locations of emergency responders have been stretched along with each floor, allowing their exact floor location to now be seen.

Although the present invention has been described in relation to particular embodiments thereof, many other variations and modifications and other uses will become apparent to those skilled in the art. Example descriptions include buildings, but can be vessels (e.g., ships, airplanes, automobiles), other man-made objects, and naturally occurring formations (mountains, caves, rock layers, galaxies).

It is preferred, therefore, that the present invention not be limited by the specific disclosure herein.

What is claimed is:

1. A method for spatially stretching hierarchical 3D/4D object models, comprising:
storing, on one or more processor readable media, one or more hierarchical 3D/4D object models containing one or more hierarchical components;
organizing, by a processor operatively coupled to the one or more processor readable media, the one or more hierarchical 3D/4D object models into a spatially stretchable structure;
defining, by the processor, spatial neighbor hierarchy components related to the one or more hierarchical 3D/4D object models;
providing, by the processor, an interactive user interface for a user to manipulate at least one of the one or more hierarchical 3D/4D object models;
receiving, by the processor, electronic information responsive to a user's selection of at least one controls in the interactive user interface to spatially manipulate and stretch at least one of the one or more hierarchical 3D/4D object models; and
updating and rendering by the processor the one or more spatially manipulated hierarchical 3D/4D object models in an interactive 3D/4D render window in response to the electronic information.

2. The method according to claim 1, further comprising organizing, by the processor, child subgraphs contained in the spatially stretchable structure for each hierarchical component within a scene graph with one or more hierarchy levels.

3. The method according to claim 2, wherein each child subgraph contains a matrix transform.

4. The method according to claim 1, further comprising organizing, by the processor, spatial neighbor chains from the spatial neighbor hierarchy components.

5. The method according to claim 1, wherein a user utilizes the user interface controls via a computer point, click and drag input device.

6. The method according to claim 1, wherein a user utilizes the user interface controls via a computer wheel or ball input device.

7. The method according to claim 1, wherein a user utilizes the user interface controls via 2D/3D graphical user interface widgets.

8. The method according to claim 1, wherein a user uses the user interface controls to spatially stretch the one or more hierarchical components and associated spatial neighbors in one or more of three spatial dimensions.

9. The method according to claim 1, further comprising augmenting, by the processor, the user interface controls by hints overlaid on the user interface, wherein the hints are operable to assist a user to identify specific hierarchical 3D/4D object model components.

10. The method according to claim 1, further comprising maintaining, by the processor, original, real-world geo-position of each hierarchical 3D/4D object model component that is manipulated.

11. The method according to claim 10, wherein a user uses the user interface controls to snap or drag stretched hierarchical 3D/4D object model components back to their original unstretched geo-position.

12. The method according to claim 1, further comprising containing, by the processor, the hierarchical 3D/4D object model within an interactive 3D/4D visual scene.

13. The method according to claim 1, further comprising displaying the 3D/4D render window on a computer-based display screen.

14. The method according to claim 1, further comprising:
accepting as input, by the processor, real-time geo-referenced data feeds; and
updating, by the processor, one or more specific sensor components that are located within the one or more hierarchical 3D/4D object models.

15. The method according to claim 14, further comprising identifying, by the processor, the one or more specific sensor components by each of the one or more sensor components' geo-location contained in the geo-referenced data feeds.

16. The method according to claim 14, further comprising identifying, by the processor, the one or more specific sensor components by meta-data contained in the geo-referenced data feeds.

17. The method according to claim 14, wherein the one or more sensor components are video surveillance cameras.

18. The method according to claim 14, wherein the one or more sensor components are sensing alarm devices.

19. The method according to claim 10, further comprising:
accepting as input, by the processor, real-time geo-referenced data feeds containing dynamic locations of mobile tracking devices; and
dynamically adding, by the processor, new hierarchical components to the one or more hierarchical 3D/4D object models representing the mobile tracking device locations.

20. The method according to claim 19, further comprising determining, by the processor, a specific 3D/4D object model hierarchical component containing the dynamic location of each geo-referenced data feed report by comparing the dynamic location with a specified bounding area relative to the original real-world geo-location of the 3D/4D object model hierarchical components.

21. The method according to claim 19, further comprising modifying, by the processor, the dynamic hierarchical components representing previous mobile tracking device locations to visually distinguish each as a previous track location.

22. The method according to claim 19, wherein the mobile tracking devices are wearable indoor tracking devices.

23. A user interface for spatially stretching hierarchical 3D/4D object models, comprising:
one or more processor readable media operatively coupled to one or more processors;
hierarchical 3D/4D object models containing one or more hierarchical components stored on the one or more processor readable media, that are organized by the one or more processors into a spatially stretchable structure;
spatial neighbor hierarchy components defined by the processor and related to the one or more hierarchical 3D/4D object models;
at least one interface control provided in the user interface that, when used by a user, manipulates at least one of the one or more hierarchical 3D/4D object models and generates electronic information, wherein the electronic information is received by the processor and used to spatially manipulate at least one of the one or more hierarchical 3D/4D object models, and further wherein the processor updates and renders the one or more spatially manipulated 3D/4D object models in an interactive 3D/4D render window in response to the electronic information.

24. The user interface of claim 23, wherein the one or more hierarchical 3D/4D object models is manipulated by stretching.
